(19) United States
(12) Patent Application Publication
(10) Pub. No.: US 2024/0218532 A1
(43) Pub. Date: Jul. 4, 2024

(54) ELECTROLYTIC CELL

(71) Applicant: WEW GmbH, Dortmund (DE)

(72) Inventor: Wiebke LÜKE, Dortmund (DE)

(21) Appl. No.: 18/277,662

(22) PCT Filed: Jan. 20, 2022
(86) PCT No.: PCT/EP2022/051176

§ 371 Date: Mar. 12, 2024

(30) Foreign Application Priority Data
Feb. 17, 2021 (DE) 102021103699.2

(51) Int. Cl. C25B 9/23; C25B 9/63; C25B 9/77

(52) U.S. Cl. CPC C25B 9/23; C25B 9/63; C25B 9/77

(57) ABSTRACT

The invention relates to an electrolytic cell comprising or consisting of (i) two metal half-cells which form the anode chamber and the cathode chamber, (ii) an anode and a cathode arranged in the anode chamber and cathode chamber respectively, (iii) a separator membrane, which separates the two electrodes from one another; (iv) for each half-cell at least one inflow and one outflow for reactant and product; and (v) optionally spacers which position the two electrodes in their respective electrode chambers, the two half-cells being connected over their perimeters, but electrically isolated from one another and having a wall thickness of 0.5 to 0.15 mm.

### FIELD OF THE INVENTION

The invention is situated in the field of electrolysis technology and relates to novel electrolytic cells, to electrolysis stacks which contain such cells connected in series, to a method for producing such stacks, and to the use of the cells in the production of the stacks.

### BACKGROUND

An economy without greenhouse gases within the next 30 years—that is the declared objective of Europe in order to stop climate change. Renewable energies are to replace fossil fuels such as oil, coal and gas. As part of the sustainable reform of energy provision, hydrogen will play an important role.

For clean mobility, the efficient provision of power and heat, as a reservoir to offset fluctuating renewable energies, as a basis for alternative fuels or as a process gas in industry—hydrogen is very versatile as an energy carrier, can be used across sector boundaries, offers great potential for synergy and, based on mass, contains an energy density that is three times that of petrol.

Sustainably and economically produced hydrogen is therefore a central component in massively reducing the emission especially of the harmful greenhouse gas CO₂ in the fields of energy, transport and industry and thereby fighting climate change. The development of an inter-sectoral hydrogen economy that is as global as possible at the same time opens up enormous opportunities for new technologies and business models, since the possible uses of hydrogen are many and varied. For industry, hydrogen-operated gas turbines are currently being explored. In fuel cells, it can be used for cars or buses. Using hydrogen, it is possible not only to drive without generating emissions, but, in contrast to electrically operated vehicles, also to cover long distances and to fuel vehicles quickly.

From the point of view of the environment, the production of hydrogen by electrolysis of water is of particular interest; the expression “green hydrogen” is therefore also used in this context. The method is carried out in coupled electrolytic cells, so-called electrolyzers, as are also known from chlorine-alkali electrolysis.

### RELEVANT PRIOR ART

An electrolytic cell is already known from U.S. Pat. No. 5,599,430 B (DOW), which comprises a housing which contains at least one pair of electrodes, namely a cathode and an anode, a current collector and a membrane. It further contains an electrically conductive, hydraulically permeable resilient mattress which is arranged substantially coplanar with the current collector and contacts the current collector on one side and likewise extends coplanar with an electrode and contacts the electrode on the other side.

EP 1451389 B1 (UHDENORA) describes a current collector for electrochemical cells, consisting of a “sandwich” of compressible and resilient layers of metal wires, which imparts a predetermined mechanical load in a broad compression range.

EP 1766104 B1 (UHDENORA) provides a conventional electrolytic cell having a sealing system consisting of individual elements which each contain two electrodes which are separated from one another by membranes and wherein the proportion of inactive membrane area is minimized by a flange so that the ratio between the area of the flange of a half-shell and the active membrane area can be set at less than 0.045.

According to EP 1882758 A1 (TOAGOSEI), the elastic pressure in an electrolytic cell is transmitted by means of coils or woven nickel mats or tough nickel alloys, in the case of coils the number of windings and in the case of mats the number of superposed layers increases stepwise from top to bottom, so that there is ultimately obtained a pressure profile that is at least similar to the hydrostatic pressure, increasing in the same direction, on the anode side.

EP 2356266 B1 (UHDENORA) describes an electrolytic cell which is provided with a separator and which has a planar, flexible cathode which is kept in contact with the separator by an elastic, conductive element pressed by a current distributor. The cell further contains an anode consisting of a punched sheet or mesh supporting the separator. The cell can be used in a modular arrangement to form an electrolyzer, of which the terminal cells only are connected to the electric power supply. The electrical continuity between adjacent cells is ensured by conducting contact strips secured to the external anodic walls of the shells delimiting each cell, wherein the stiffness of the cathode current distributor and of the anodic structure and the elasticity of the conductive element cooperate in maintaining a uniform cathode-to-separator contact with a homogeneous pressure distribution, while at the same time a suitable mechanical load on the contact strips is ensured. Spacing of the electrodes is thus avoided by the use of the elastic element.

EP 2734658 B1 (NEW NEL HYDROGEN) comprises a module for an electrolyzer of the filter-press type comprising at least one closed frame defining at least one first opening, wherein the module represents a sealing and electrically insulating material and this material at least partly covers the surface of the frame.

EP 2746429 A1 (UHDENORA) proposes an electrolytic cell which contains an anode compartment with an anode and a cathode gas compartment with a gas diffusion cathode, wherein the two electrodes are separated from one another by an ion exchange membrane, and a metallic elastic element which is clamped under compression between the back wall of the cathode gas compartment and the gas diffusion cathode, wherein said elastic element is clamped into the cathode gas compartment such that the distance between the element and the back wall increases in the direction of gravity.

EP 2872675 B1 (UHDENORA) proposes an insulating frame for electrolytic cells which has a geometric form with corners, wherein the frame is of flat design and has an anode and a cathode side as well as an outer and an inner end face. The insulating frame has an edge area which directly adjoins the inner end face and which has openings in the form of cut-outs in the region of the corners.

According to JP 2003 041388 A1 (ASFPONC), stabilization of the cell is achieved by a metallic zigzag profile which is installed in the cathode gas chamber. However, this form of the electrolytic cell causes a problem: physics actually requires that the hydrostatic pressure in the anode compartment is not constant but increases in the direction of gravity. It would therefore be desirable and entirely sufficient within the meaning of the objective to be achieved that the pressure exerted by the resilient built-in components adapts to the hydrostatic pressure, that is to say increases in the direction of gravity.

### SUMMARY

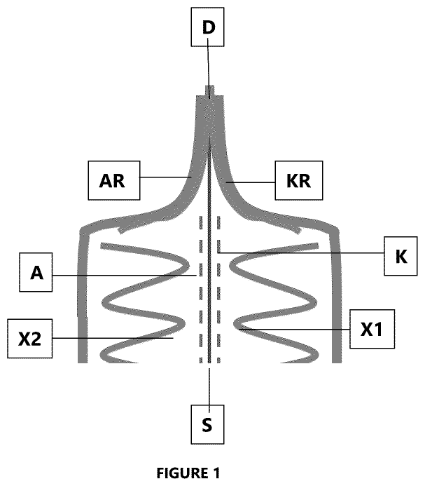

An electrolytic cell consists, schematically, of an anode chamber and a cathode chamber (AR, KR), which contain the anode (A) and the cathode (K), respectively. The two electrodes are on the one hand separated from one another by a diaphragm or separator membrane (S) and on the other hand fixed in the corresponding housing parts (“half-cells”) by means of a resilient or rigid spacer (X1, X2), as can be seen schematically in FIG. 1. There can additionally be seen in the figure a seal (D) which connects the two electrode chambers at the perimeter but electrically insulates and seals them to the outside.

The anode and cathode chambers must be electrically insulated from one another so that a short circuit does not occur. For optimal performance, it is further necessary that the electrodes lie flat—that is to say without gaps—on the separator membrane over their entire surface. This is achieved by one or more resilient spacers (X1, X2) inside the cell. In addition, the electrolytic cell is placed under slight excess pressure relative to the atmosphere, which means that the seal must be both chemically resistant and pressure-resistant.

According to the prior art, electrolytic half-cells are manufactured from metal sheets which have a thickness of at least 0.5 mm in order to provide the cells with sufficient stability and in order to ensure that they are not damaged during transport or installation in an electrolyzer or an electrolysis stack. However, this has the disadvantage that the cells become very heavy and rigid, which presents problems on installation and of course also leads to a high material value.

### DESCRIPTION OF THE INVENTION

In a first embodiment, the invention relates to an electrolytic cell comprising or consisting of
(i) two metallic half-cells which form the anode chamber and the cathode chamber,
(ii) an anode and a cathode arranged in the anode chamber and cathode chamber, respectively,
(iii) a separator membrane which separates the two electrodes from one another,
(iv) for each half-cell at least one inlet and one outlet for reactant and product, and
(v) optionally spacers which position the two electrodes in their respective electrode chambers,
   wherein the two half-cells are connected over their perimeter but electrically insulated and have a wall thickness of from 0.05 to 0.15 mm and in particular from 0.070 to 0.1 mm.

Preferably, the electrolytic cells are subject to a slight low pressure of, for example, from 0.5 to 0.15 bar, so that the cells are vacuum-stiffened and can thus be transported and subsequently stacked particularly easily and safely.

Surprisingly, it has been found that, contrary to scientific opinion, it is readily possible to produce electrolytic cells that fully meet the requirements mentioned at the beginning using very thin metal sheets, preferably metal foils.

### Electrolytic Cell

The anode and cathode are preferably arranged in the cell as shown schematically in FIG. 1, namely such that the two electrodes are positioned flat and without gaps relative to one another over their entire surface, wherein only the separator membrane connects direct contact.

The half-cells preferably consist of stainless steel, nickel or titanium as well as corresponding alloys, which may also contain further foreign metals such as, for example, vanadium.

The spacers can be resilient elements, such as, for example, coils, rings, foams, mattresses, or rigid structures, as have been discussed at the beginning in the evaluation of the prior art. They can be static or resilient, wherein it is preferred to equip at least one electrode chamber with resilient spacers in order to ensure that the electrodes will lie flat.

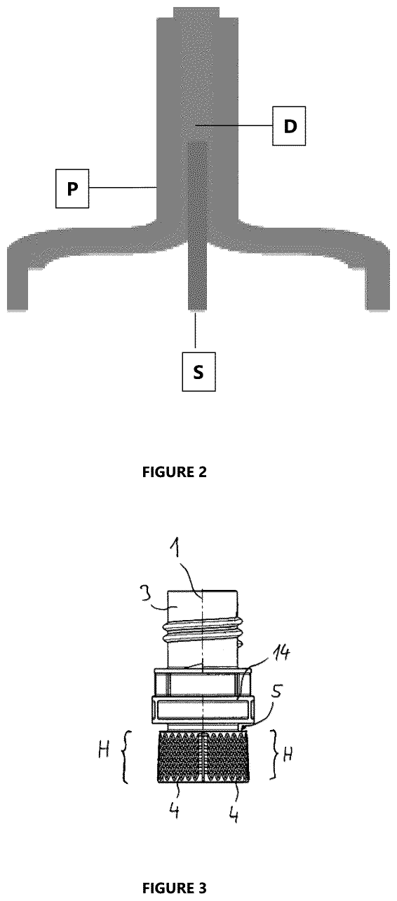

Although the two half-cells must be connected to one another over their perimeter, they must be electrically insulated from one another. This can preferably be effected by introducing a sealing composition. FIG. 2 shows schematically a cross-section of the perimeter (P) over which the sealing composition (D) is distributed; in the middle, the separator membrane (S) can be seen, the ends of which are likewise surrounded by the sealing composition. In this way, the membrane is simultaneously fixed and stabilized in the cell.

The plastics composition can be introduced by the conventional methods of plastics processing, that is to say, for example, by thermal direct joining, adhesive bonding, hot melt or lamination. Particular preference is given to thermal direct joining because it is technically undemanding. It functions very similarly to the injection molding process: the plastics material is liquefied and injected into the seal face. The polymer, as a result of cooling, there changes into the solid state again and seals the two half-cells. Suitable electrically insulating plastics materials are in principle thermoplastics, wherein preference is given to perfluoroalkoxy polymers (PFA) and polyphenyl sulfides (PPS) owing to their high chemical resistance.

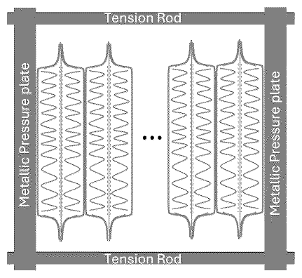

In a further preferred embodiment of the present invention, inlets and outlets for the product and the reactant are located in the joints between the two half-cells. There come into consideration in particular connections that are known from the foodstuffs industry, such as the welded-in spouts of injection-moldable plastics material illustrated in FIG. 3. Corresponding connections or spouts are provided in EP 2644530 A1 (POPPELMANN), the teaching of which, where it relates to the nature of the spouts, is incorporated by reference. The connections or spouts have a neck (3) provided with a pouring channel (2) having a vertical longitudinal central axis (1), as well as two outer side surfaces which are connected thereto and are preferably provided with welding lines, which side surfaces are provided for welding to the seal of the electrolytic cell and on the associated side walls of which there are arranged on the inside a plurality of stiffening webs.

The mentioned outlets or spouts generally have a base, also called a “boat”, the side walls of which have outer side surfaces which merge with one another at their end regions. The side surfaces are connected, in particular welded, to and between the two foil walls of a container. A collar-like region, which merges into a neck which has a pouring channel which has a vertical longitudinal central axis, is formed on the boat or side surfaces, typically in one piece. Such a neck is often provided with a thread on the outside in order to secure a filled foil pouch with a cap before emptying through the pouring channel. Alternatively, the neck can also merge, at least partially, directly into the boat. The side surfaces of the boat can be flat, rough, with or without ribs and/or provided with welding lines. In addition, the neck can have guide webs which can be used for guiding in a filling or sealing system.

According to the teaching of EP 2644530 A1, the connections or spouts are generally connected to the seal by ultrasonic welding. In this invention, welded-on spouts are preferably introduced directly in the joining process.

### Electrolysis Stack and Method for the Production Thereof

The individual electrolytic cells can be combined into groups which are referred to as “electrolyzers” or “electrolysis stacks”. The invention therefore further provides an electrolysis stack, comprising or consisting of
(i) at least two electrolytic cells as described at the beginning,
(ii) two (metallic) pressure plates, and
(iii) at least two tension rods,
   wherein
(a) the two pressure plates are opposite one another and are spaced apart movably or rigidly by the at least two tension rods, and a high electrical resistance or insulation is preferably present in the connection by the tension rods;
(b) the at least two electrolytic cells are arranged or stacked relative to one another between the two pressure plates such that in each case the cathodic rear wall of the first electrolytic cell is in contact with the anodic rear wall of the following electrolytic cell; and
(c) the pressure plates are spaced apart from one another such that, together with the at least two vacuum-stiffened electrolytic cells, there is a fixed association.

The stacks of the present invention contain preferably 3, 4, 5 or up to approximately 200 of the mentioned electrolytic cells. Preferably, they contain from approximately 40 to approximately 150 and in particular from approximately 60 to approximately 120.

A typical electrolysis stack is shown in FIG. 4, wherein the electrolytic cells which can be seen therein each have the construction according to FIG. 1.

There is likewise claimed a method for producing an electrolysis stack, comprising or consisting of the following steps:
(i) providing at least two electrolytic cells as claimed in claim 1,
(ii) providing two pressure plates, and
(iii) providing at least two tension rods,
   wherein
(a) the at least two electrolytic cells are vacuum-stiffened by application of a low pressure;
(b) the vacuum-stiffened electrolytic cells from step (a) are connected electrically in series in that they are arranged or stacked relative to one another such that in each case the cathodic rear wall of the first electrolytic cell is in contact with the anodic rear wall of the following electrolytic cell;
(c) the vacuum-stiffened electrolytic cells so connected in series according to step (b) are arranged between the two pressure plates by means of the at least two tension rods such that a fixed association is produced; and
(d) the vacuum on the electrolytic cells in the fixed association is released again.

By means of the configuration according to the invention, a conventional single-cell design can also be applied to cells with a small wall thickness. According to the invention, these thin sheets or foils are used as the shell and are electrically separated from one another by the joining and the separator, wherein the built-in components are introduced during the manufacturing process. Following the manufacturing process, the cells are subject to a low pressure, which effects precompression of the resilient element or mattress on the inside. At the same time, the cells are vacuum-stiffened by this operation, which offers the following advantages and hitherto does not correspond to the prior art in this technology:
stiffening of flexible components,
achievement of transportability by, for example, vacuum lifting systems or mechanical gripper systems without additional assistance,
testing of tightness,
detection of damage as a result of transport, and
preloading of the resilient elements of the system.

As a result of the preloading of the elements, the cells can be introduced into a stack which does not have to be equipped with a clamping device but which presses the resilient elements together and offers the possibility of compression including displacement of the pressure plate. The metallic pressure plates can be held together simply by tension rods and, on initial assembly, can simply be brought into contact with the vacuum-stiffened elements. By releasing the vacuum, the resilient elements are no longer loaded by the external pressure but are now held in position by the pressure plates.

The resulting stacks can be used in chlorine-alkali electrolysis, for example, but the preferred intended use is the production of hydrogen by electrolysis of water.

### INDUSTRIAL APPLICABILITY

The invention further provides the use of the electrolytic cells according to the invention in the production of electrolysis stacks.

1. An electrolytic cell comprising or consisting of
(i) two metallic half-cells which form the anode chamber and the cathode chamber,
(ii) an anode and a cathode arranged in the anode chamber and cathode chamber, respectively,
(iii) a separator membrane which separates the two electrodes from one another,
(iv) for each half-cell at least one inlet and one outlet for reactant and product, and
(v) optionally spacers which position the two electrodes in their respective electrode chambers,
wherein the two half-cells are connected over their perimeter but electrically insulated and have a wall thickness of from 0.05 to 0.15 mm.

2. The electrolytic cell as claimed in claim 1, wherein the half-cells are comprised of stainless steel, nickel or titanium or an alloy thereof, the half-cells optionally further comprising foreign atoms.

3. The electrolytic cell as claimed in claim 1, wherein the spacers are resilient elements.

4. The electrolytic cell as claimed in claim 1, wherein the two metallic half-cells are connected over their perimeter by an electrically insulating plastics material.

5. The electrolytic cell as claimed in claim 1, wherein the inlet and outlet are welded-in spouts of injection-moldable plastics material.

6. The electrolytic cell as claimed in claim 1, wherein the electrolytic cell is vacuum-stiffened.

7. An electrolysis stack, comprising or consisting of
(i) at least two electrolytic cells as claimed in claim 1,
(ii) two pressure plates, and
(iii) at least two tension rods,
wherein
(a) the two pressure plates are opposite one another and are spaced apart movably or rigidly by the at least two tension rods;
(b) the at least two electrolytic cells are arranged or stacked relative to one another between the two pressure plates such that in each case the cathodic rear wall of the first electrolytic cell is in contact with the anodic rear wall of the following electrolytic cell; and
(c) the pressure plates are spaced apart from one another such that, together with the at least two vacuum-stiffened electrolytic cells, there is a fixed association.

8. The electrolysis stack as claimed in claim 7, wherein the electrolysis stack contains from 2 to approximately 150 electrolytic cells.

9. A method for producing an electrolysis stack, comprising or consisting of the following steps:
(i) providing at least two electrolytic cells as claimed in claim 1,
(ii) providing two pressure plates, and
(iii) providing at least two tension rods,
wherein
(a) the at least two electrolytic cells are vacuum-stiffened by application of a low pressure;
(b) the vacuum-stiffened electrolytic cells from step (a) are connected electrically in series in that they are arranged or stacked relative to one another such that in each case the cathodic rear wall of the first electrolytic cell is in contact with the anodic rear wall of the following electrolytic cell;
(c) the vacuum-stiffened electrolytic cells so connected in series according to step (b) are arranged between the two pressure plates by means of the at least two tension rods such that a fixed association is produced; and
(d) the vacuum on the electrolytic cells in the fixed association is released again.

10. (canceled)

11. A method of producing electrolysis stacks, the method comprising combining two or more electrolytic cells as claimed in claim 1.
